(19) United States
(12) Patent Application Publication
(10) Pub. No.: US 2020/0175017 A1
(43) Pub. Date: Jun. 4, 2020

(54) COST RANKING DETERMINING DEVICE, METHOD AND PROGRAM

(71) Applicant: NEC Corporation, Minato-ku, Tokyo (JP)

(72) Inventor: Florian BEYE, Tokyo (JP)

(73) Assignee: NEC Corporation, Minato-ku, Tokyo (JP)

(21) Appl. No.: 16/628,302

(22) PCT Filed: Jul. 5, 2017
(86) PCT No.: PCT/JP2017/024619

§ 371 Date: Jan. 3, 2020

(51) Int. Cl. G06F 16/2453; G06F 16/2457; G06F 16/2458

(52) U.S. Cl. CPC G06F 16/24542; G06F 16/2458; G06F 16/24578

(57) ABSTRACT

A cost ranking determining device for determining a cost ranking comprises a search area setting unit 1 which initially sets a search area where solution candidates are included, and serially sets a new search area based on one or more of determined the Pareto points, an acquiring unit 2 which acquires information whether the search area includes a solution candidate or solution candidates satisfying predetermined constraints, and the new search area include a solution candidate or solution candidates satisfying predetermined constraints, a determining unit 3 which determines Pareto points in the search area and the new search area under the condition where a solution candidate satisfying the constraints is regarded as a solution, and a generating unit 4 which generates a ranking of the solutions in cost according to the determined Pareto fronts.

### TECHNICAL FIELD

The present invention relates to a method for determining a cost ranking on a constrained finite multivariate search space.

### BACKGROUND ART

Methods for determining optimal solutions to various categories of optimization problems are abound in the literature. Contrastingly, methods that determine a ranking of solutions (i.e. a list of solutions ordered by the value of the objective function of the problem, starting from an optimal solution) are scarce. However, determining a ranking is useful in e.g. the following cases.

(1) When mathematically formulating some particular constraints of the problem is infeasible, for example when a constraint involves decision made by a human.

(2) Where evaluation of some particular constraints is time-intensive, even if all constraints can in principle be encoded mathematically inside the optimization problem.

Then, the optimal solution can be obtained by first generating a ranking of solutions with a reduced set of conditions, and then verifying the remaining constraints while iterating over the ranking, starting from the best one.

For example, Non-Patent Literature 1 (NPL 1) discloses a method for finding a ranking of K best solutions to an optimization problem formulated in terms of N binary variables. It assumes the existence of a method to find the overall best solution to that optimization problem under the restriction that a subset of the N binary variables is fixed, i.e. assigned specific values.

Non-Patent Literature 2 (NPL 2) describes a method for parallelizing the execution of the method disclosed in NPL 1. However, it does not address the inherent inefficiency of the method disclosed in NPL 1.

### CITATION LIST

### Non Patent Literature

[NPL 1]

E. L. Lawler “A PROCEDURE FOR COMPUTING THE K BEST SOLUTIONS TO DISCRETE OPTIMIZATION PROBLEMS AND ITS APPLICATION TO THE SHORTEST PATH PROBLEM”, MANAGEMENT SCIENCE, Vol. 18 No. 7, PP. 401-405, March 1972
[NPL 2]

K. Golenberg et al. “Optimizing and Parallelizing Ranked Enumeration”, PVLDB 4(11), PP. 1028-1039, 2011

### SUMMARY OF INVENTION

### Technical Problem

The method disclosed in NPL 1 shows an inefficiency that can lead to long running times. This is due to it being prone to redundantly generating equivalent knowledge multiple times, when it repeatedly invokes a method for determining overall best solutions.

In view of this, an exemplary object of the present invention is to provide a method that is able to efficiently determine a cost ranking.

### Solution to Problem

A cost ranking determining method for determining a cost ranking according to the present invention comprises initially setting a search area where solution candidates are included, acquiring information whether the search area includes a solution candidate or solution candidates satisfying predetermined constraints, determining Pareto points in the search area under the condition where a solution candidate satisfying the constraints is regarded as a solution, serially setting a new search area based on one or more of the determined Pareto points, acquiring information whether the new search area includes a solution candidate or solution candidates satisfying predetermined constraints, determining Pareto points in the new search area under the condition where a solution candidate satisfying the constraints is regarded as a solution, and generating a ranking of the solutions in cost according to the determined Pareto fronts.

A method applicable to a cost ranking determining method for determining a cost ranking according to the present invention comprises initially setting a search area where solution candidates are included, receiving Pareto points in the search area under the condition where a solution candidate satisfying the constraints is regarded as a solution, serially setting a new search area based on one or more of the determined Pareto points, receiving Pareto points in the new search area under the condition where a solution candidate satisfying the constraints is regarded as a solution, and generating a ranking of the solutions in cost according to the determined Pareto fronts.

Another aspect of a method applicable to a cost ranking determining method for determining a cost ranking according to the present invention comprises acquiring information whether a search area includes a solution candidate or solution candidates satisfying predetermined constraints, determining Pareto points in the search area under the condition where a solution candidate satisfying the constraints is regarded as a solution, acquiring information whether a new search area based on one or more of the determined Pareto points includes a solution candidate or solution candidates satisfying predetermined constraints, and determining Pareto points in the new search area under the condition where a solution candidate satisfying the constraints is regarded as a solution.

A cost ranking determining device for determining a cost ranking according to the present invention comprises search area setting means for initially setting a search area where solution candidates are included, and serially setting a new search area based on one or more of the determined Pareto points, acquiring means for acquiring information whether the search area includes a solution candidate or solution candidates satisfying predetermined constraints, and whether the new search area includes a solution candidate or solution candidates satisfying predetermined constraints, determining means for determining Pareto points in the search area and the new search area under the condition where a solution candidate satisfying the constraints is regarded as a solution, and generating means for generating a ranking of the solutions in cost according to the determined Pareto fronts.

A cost ranking determining program for determining a cost ranking according to the present invention causes a computer to execute a process of initially setting a search area where solution candidates are included, a process of acquiring information whether the search area includes a solution candidate or candidates satisfying predetermined constraints, a process of determining Pareto points in the search area under the condition where a solution candidate satisfying the constraints is regarded as a solution, a process of serially setting a new search area based on one or more of the determined Pareto points, a process of acquiring information whether the new search area includes a solution candidate or solution candidates satisfying predetermined constraints, a process of determining Pareto points in the new search area under the condition where a solution candidate satisfying the constraints is regarded as a solution, and a process of generating a ranking of the solutions in cost according to the determined Pareto fronts.

### Advantageous Effects of Invention

According to the present invention, a cost ranking is efficiently determined, because the method of this invention avoids generating the same knowledge repeatedly, leading to faster execution times.

### BRIEF DESCRIPTION OF DRAWINGS

FIG. 1 It is a block diagram showing an exemplary embodiment of a cost ranking determining device.

FIG. 2 It is a flowchart showing an example of an operation of the ranking generation unit.

FIG. 3 It is a flowchart showing an example of an operation of the Pareto front generation unit.

FIG. 4 It is an explanatory diagram for explaining operation of the cost ranking determining device.

FIG. 5 It is an explanatory diagram for explaining operation of the cost ranking determining device.

FIG. 6 It is an explanatory diagram for explaining operation of the cost ranking determining device.

FIG. 7 It is a block diagram showing mainly functional units for determining a cost ranking.

FIG. 8 It is a block diagram showing a ranking generation unit applicable to an exemplary embodiment of a cost ranking determining device.

FIG. 9 It is a block diagram showing a Pareto front generation unit applicable to an exemplary embodiment of a cost ranking determining device.

FIG. 10 It is a block diagram illustrating a configuration example of an information processing system capable of implementing the functions of a cost ranking determining device.

FIG. 11 It is an explanatory diagram for explaining a service function chain consisting of three service functions operating on a stream of data.

FIG. 12 It is an explanatory diagram for explaining a specific example of SFC.

FIG. 13 It is a block diagram showing main parts of a cost ranking determining device.

FIG. 14 It is a block diagram showing main parts of another cost ranking determining device.

### DESCRIPTION OF EMBODIMENTS

For example, this invention can be used for the determination of a ranking of solutions to optimization problems that can be formulated such as to fall in the following categories.
a) The problem is formulated in N integer variables x_1, . . . , x_N, which are restricted to finite ranges.
b) The problem specifies an objective function (cost function) that assigns each valid (as in a)) assignment to the variables x_1, . . . , x_N a cost value. In the following, better solutions are referred to as cheaper solutions, and best solutions are referred to as cheapest solutions.
c) The cost function specified in the problem increases monotonically as the value of any of the variables increase (cost(x_1, . . . , x_i+1, . . . x _N)>=cost(x_1, . . . , x_i, . . . , x_N) for all i, and all possible assignments of the variables).
d) The N variables of the optimization problem are subject to further arbitrary constraints.

However, this invention is applied not only under the above categories.

The following terms are defined in the present description.
1) A “point” shall denote a specific assignment of integer values to the variables x_1, . . . , x_N (please refer to the above a)).
2) A point is called “feasible” if it satisfies the constraints specified in the above d). Alternatively, a feasible point is called a “solution” to the optimization problem. A point before being determined whether satisfying the constraints or not shall be called “solution candidate”.
3) A point Y=(y_1, . . . , y_N) is said to “dominate” another point X=(x_1, . . . , x_N) whenever y_i <=xi for all i and y_i<x_i for at least a single i.
4) A ranking of solutions to the optimization problem is given by an ordered list [X_1, . . . , X_K] of feasible points with the following properties.

(i) A feasible point is contained at most once inside the list, so K is some number less than or equal to the total number of feasible points.

(ii) cost(X_i)<32 cost(X_(i+1)) for all i.

(iii) The list contains all feasible points of the problem with cost less than cost(X_K). In case the optimization problem has no solutions, the ranking is given by an empty list.
5) For a given set S of points, a point X is called a “Pareto point in S” if

(i) X is contained in the set S,

(ii) X is feasible, and

(iii) there does not exist any other feasible point Y contained in S which dominates X.
6) For a given set S of points, the “Pareto front in S” is the set of all Pareto points in S.
7) A set S of points is said to be “mutually independent” if no single point X in S is dominated by any other single point Yin S.

It should be noted that the points belonging to a Pareto front are always mutually independent.

### Exemplary Embodiment 1

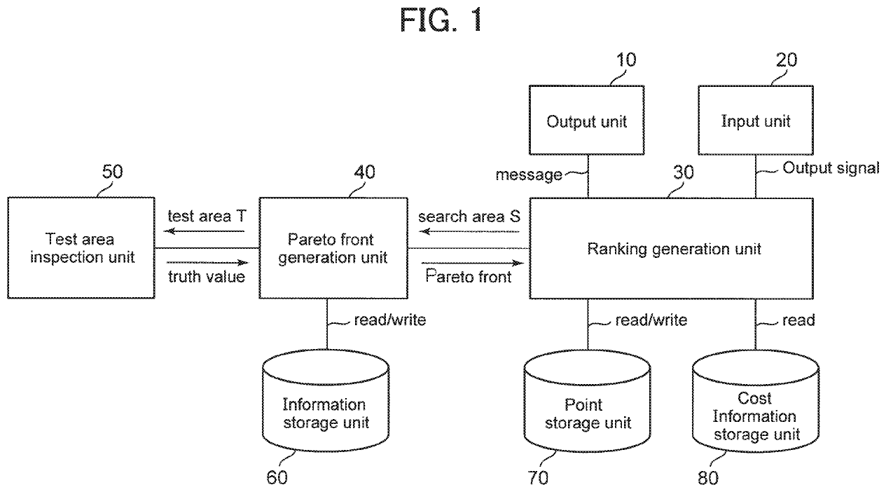

FIG. 1 is a block diagram showing an exemplary embodiment of a cost ranking determining device.

As shown in FIG. 1, a cost ranking determining device comprises an output unit 10, an input unit 20, a ranking generation unit 30, a Pareto front generation unit 40, a test area inspection unit 50, an information storage unit 60, a point storage unit 70 and a cost information storage unit 80.

The output unit 10 can generate a signal which is sent to the ranking generation unit 30. The input unit 20 receives feasible points (solutions of the optimization problem) from the ranking generation unit 30, as well as “end of output” messages which signal that all feasible points have been output.

The ranking generation unit 30 is responsible for generating a ranking of solutions, by querying Pareto fronts from the Pareto front generation unit 40, and operating on several sets of points recorded in the point storage unit 70.

The Pareto front generation unit 40 receives an abstractly represented search area S (a set of points) from the ranking generation unit 30 and returns the Pareto front in S to the ranking generation unit 30, by repeatedly querying information about the existence of feasible points inside subsets T of S from the test area inspection unit 50, and accumulating the received information in the information storage unit 60.

The test area inspection unit 50 inspects an abstractly represented a test area T (a set of points) which it has received from the Pareto front generation unit 40 and returns information about the existence of feasible points inside that set to the Pareto front generation unit 40. It returns a truth value as follows.
(i) If T contains at least two points and if it does not contain any feasible point, then the truth value must be either “True” or “False”.
(ii) If T consists of only a single point and if that point is not feasible, then the truth value must be “False”.
(iii) If T contains at least one feasible point, then the truth value must be “True”.

The information storage unit 60 stores a set feasible points, information about non-existence of feasible points inside sets of points, as well as information about whether a set of points has already been inspected by the test area inspection unit 50.

The point storage unit 70 stores sets of points.

The cost information storage unit 80 stores information sufficient to determine the cost of each point.

In addition, the Pareto front generation unit 40 and the test area inspection unit 50 should agree on the allowed sets of points which are accepted by the test area inspection unit 50 as test area T. Further, the set of sets of points that the test area inspection unit 50 accepts as input is a superset of the set of all sets containing only a single point.

It should be noted that all details which are specific to the given optimization problem need not be known to units other than the test area inspection unit 50.

An operation of the cost ranking determining device of the present exemplary embodiment is described below.

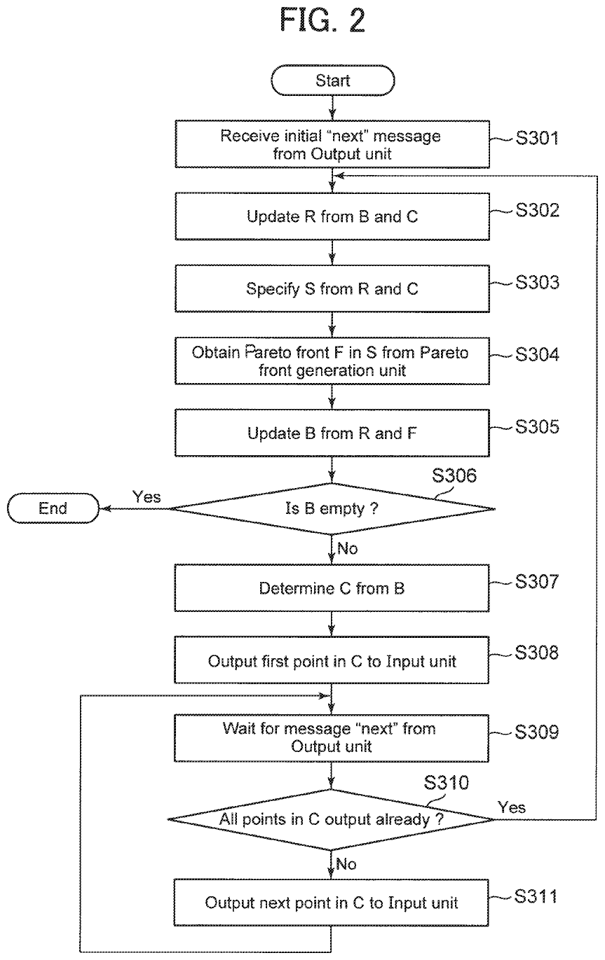

FIG. 2 is a flowchart showing an example of an operation of the ranking generation unit 30. In this exemplary embodiment, an output of the ranking generation unit 30 is a ranking of solutions to an optimization problem, as defined in the above 4).

The ranking generation unit 30 keeps track of three point sets denoted as B, R and C, which are stored in the point storage unit 70. The point storage unit 70 is assumed to be empty immediately after the ranking generation unit 30 begins operation.

In the initial state, the ranking generation unit 30 inputs a “next” message from the output unit 10 (step S301). Specifically, the operation of the ranking generation unit 30 is triggered by input of a “next” message from the output unit 10.

Then, in step S302, the ranking generation unit 30 updates the set R from B and C, by assigning it the set-theoretic difference of B and C, that is R=B−C. It should be noted that the set-theoretic difference results in the subset of all points contained in B which are not contained in C.

Next, in step S303, the ranking generation unit 30 specifies, using R and C, a “search area” as the set S of all points X satisfying the following conditions.
condition (i) X is dominated by at least a single point Y in C (if C is non-empty).
condition (ii) X is not dominated by any point Y in R.

Subsequently, the ranking generation unit 30 sends the search area S to the Pareto front generation unit 40. The Pareto front generation unit 40 then determines the Pareto front F in S as described below and sends it to the ranking generation unit 30. Thus, the ranking generation unit 30 obtains Pareto front F in S from the Pareto front generation unit 40 (step S304).

When receiving the Pareto front F, the ranking generation unit 30 updates the set B of points to be the set-theoretic (disjoint) union of F and R, B=F+R (the set of all points contained in either F or R) (step S305).

Next, in step S306, the ranking generation unit 30 checks whether the set B is empty. If B is empty, it is concluded that the unit has finished outputting the ranking of all feasible points, and subsequently the unit sends a “end of output” message to the input unit 20 and stops operation.

If B is not empty, the ranking generation unit 30 assigns to C the subset of B containing all points in B with the cheapest overall cost of points in B (step S307). To achieve this, the ranking generation unit 30 queries cost information stored in the cost information storage unit 80 for each single point in B.

Then, the ranking generation unit 30 begins to output each single point in C. However, after outputting a single point, the ranking generation unit 30 enters a suspended state, waiting for reception of a “next” message from the output unit 10, only after retrieval of which it resumes operation (steps S308-S311).

After all points in C have been output, the ranking generation unit 30 continues operation by returning to step S302.

To easily comprehend the operation of this exemplary embodiment, followings should be paid attention to.
(i) The points in set B are always mutually independent.
(ii) Using the monotonicity of the cost function as stated in the above c), it can be deduced that the totally cheapest feasible point contained in S is necessarily contained in the output F of the Pareto front generation unit 40 to the ranking generation unit 30 in step S304.
(iii) From the above c) and the definition of the Pareto front in the above 6), also the following can be deduced: the set S, at the time when it is determined in step S303, necessarily contains all feasible points not output yet whose cost is higher than or equal to the cost of any point in C (which all have identical cost), and lower than the cost of any point in R.

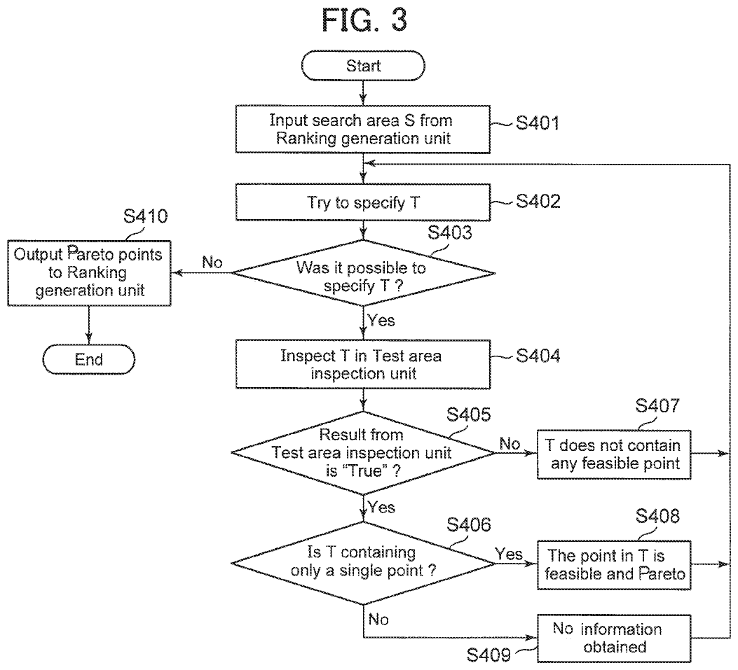

Next, an operation of the Pareto front generation unit 40 is explained. FIG. 3 is a flowchart showing an example of an operation of the Pareto front generation unit 40.

At first, the Pareto front generation unit 40 inputs a search area S from the ranking generation unit 30 (step S401). Specifically, the operation of the Pareto front generation unit 40 is triggered by input of a search area S from the ranking generation unit 30. At this time, the information storage unit 60 is assumed to be empty.

Then, in step S402, the Pareto front generation unit 40 attempts to specify a non-empty subset T of S satisfying the following criteria.
criterion (i) All points Y in S-T (the subset of all points contained in S which are not contained in T) dominating any point X in T were disproven to be feasible.
criterion (ii) The set T does neither contain points which were proven to be feasible, nor does it contain points which were disproven so.
criterion (iii) The identical T has not been inspected yet in step S304.
criterion (iv) The set T is contained in the set of possible inputs accepted by the Pareto front generation unit 40.

In step S402, the Pareto front generation unit 40 evaluates the above criteria (i)- (iii) by querying the information stored in the information storage unit 60. If it is not possible to specify a set T of points meeting the above four criteria, the Pareto front generation unit 40 outputs the set of feasible points recorded in the information storage unit 60 to the ranking generation unit 30 (steps S403, S410). Then, the Pareto front generation unit 40 clears the information stored in the information storage unit 60 and suspends operation until reception of another search area.

When it is possible to specify a set T of points meeting the above four criteria, the Pareto front generation unit 40 sends that set T to the test area inspection unit 50 where a truth value is generated and sent back to the Pareto front generation unit 40 (steps S403, S404).

When the truth value is “False”, the information that T does not contain any feasible point can be deduced, and the Pareto front generation unit 40 stores this information in the information storage unit 60 (steps S405, S407). Then, the procedure proceeds to step S402.

When the truth value is “True” and T contains only a single point, the information that the point in T is a feasible can be deduced, and the Pareto front generation unit 40 records this information in the information storage unit 60 (steps S406, S408). Then, the procedure proceeds to step S402. Otherwise, nothing can be deduced about the existence of a feasible point inside T, and the Pareto front generation unit 40 records the information that T has undergone inspection by the test area inspection unit 50 in the information storage unit 60 (steps S406, S409). Then, the procedure proceeds to step S402. Therefore, the Pareto front generation unit 40 continues operation by repeating the above steps, starting at step S402.

It should be noted that for correct operation of the Pareto front generation unit 40, the actual method to specify T in step S402 is not relevant, as long as the produced T satisfies the above criteria (i)-(iv).

In addition, all points proven to be feasible during the operation of this method are also Pareto due to the above criterion (i). Further, the criterion (ii) ensures that no unnecessary testing is done, whereas the criterion (iii) ensures convergence of the method, and that the set of feasible points stored in the information storage unit 60 is identical to the Pareto front in S after finishing.

As described above, in this exemplary embodiment, it is prevented that an identical area is tested repeatedly for solutions satisfying the constraints of the optimization problem. Thus, redundant calculation work is prevented and long execution time is not required.

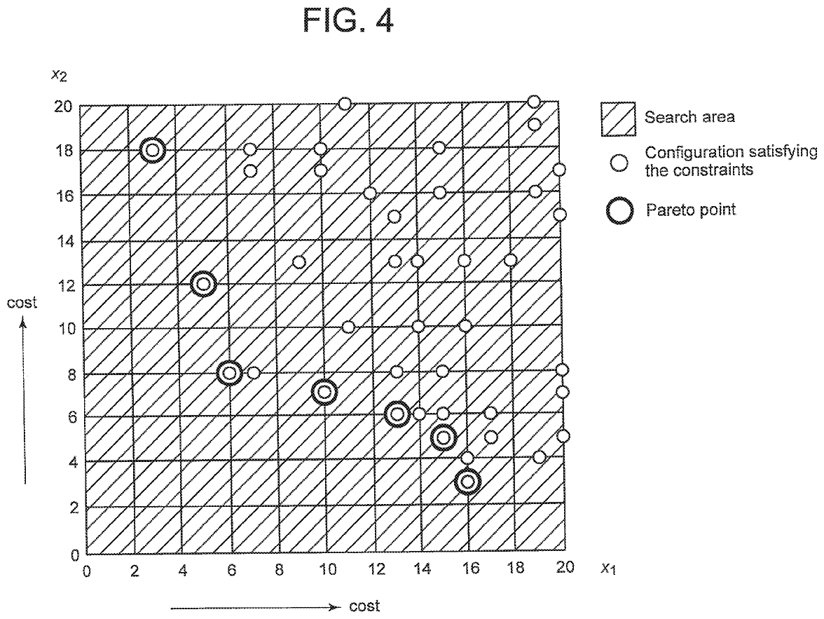

FIGS. 4 to 6 are explanatory diagrams for explaining operation, for example, of the cost ranking determining device. FIG. 4 shows a search area where solution candidates are included. However, in FIG. 4, solutions which satisfy predetermined constraints are shown. In addition, seven Pareto points are shown for example.

The ranking generation unit 30 initially sets a search area, as shown in FIG. 1, where solution candidates are included and outputs the search area. The Pareto front generation unit 40 acquires information whether the search area includes a solution candidate or solution candidates satisfying predetermined constraints from the test area inspection unit 50. The ranking generation unit 30 determines Pareto points in the search area under the condition where a solution candidate satisfying the constraints is regarded as a solution. The Pareto front generation unit 40 provides the ranking generation unit 30 with a Pareto front (complete set of Pareto points).

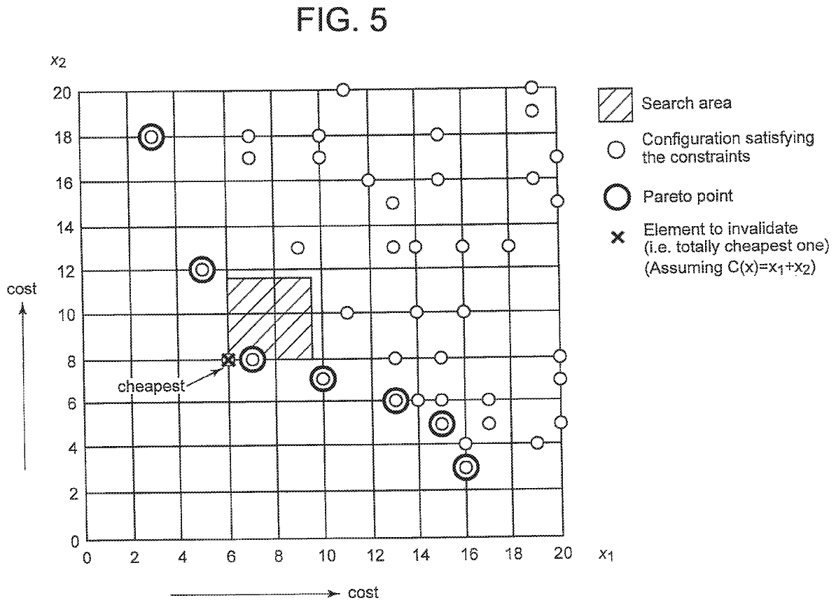

FIG. 5 shows a search area where solution candidates are included. However, in FIG. 5, solutions which satisfy predetermined constraints are shown. The ranking generation unit 30 sets a new search area based on the cheapest of the determined Pareto points. In the example shown in FIG. 5, the ranking generation unit 30 sets a new search area which contains all solution candidates of cost lower than the cost of each remaining Pareto point and higher than the cost of the cheapest point.

In the example shown in FIG. 5, there is a single solution in the new search area, which is the second cheapest point. Thus, the ranking generation unit 30 sets a new search area which contains all solution candidates of cost lower than the cost of each remaining Pareto point and higher than the cost of the second cheapest point.

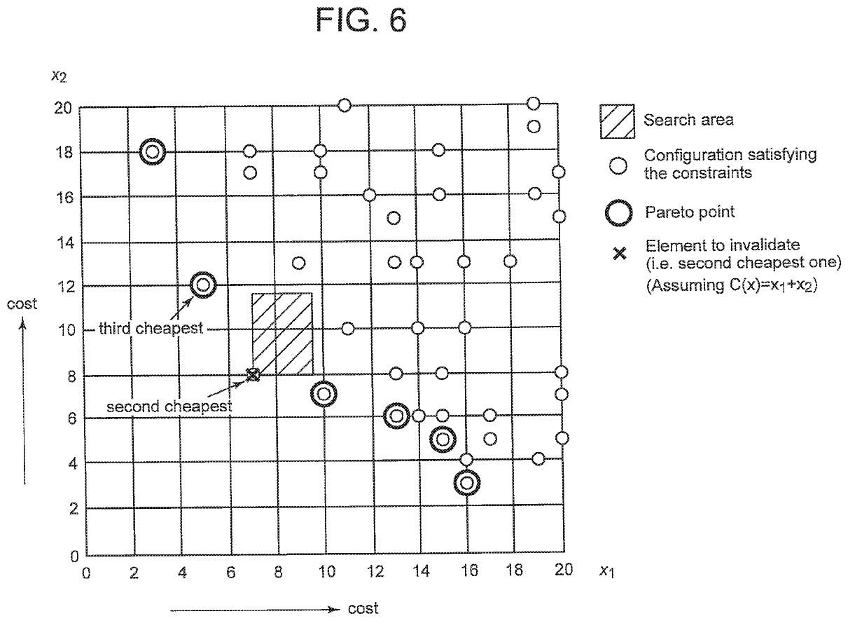

In the example shown in FIG. 6, there is no solution candidate in the new search area.

The ranking generation unit 30 outputs the new search area to the Pareto front generation unit 40. The Pareto front generation unit 40 acquires information whether the new search area includes a solution candidate or solution candidates satisfying predetermined constraints from the test area inspection unit 50. The ranking generation unit 30 determines Pareto points in the new search area under the condition where a solution candidate satisfying the constraints is regarded as a solution. The Pareto front generation unit 40 provides the ranking generation unit 30 with Pareto points.

The ranking generation unit 30 repeatedly sets a new search area in the above mentioned manner. Thus, the Pareto front generation unit 40 provides the ranking generation unit 30 with Pareto fronts repeatedly. In other words, the ranking generation unit 30 serially inputs Pareto fronts. Since the cost information storage unit 80 stores information sufficient to determine the cost of each point (each solution), the ranking generation unit 30 can rank solutions in cost while referring to the cost information storage unit 80.

### Exemplary Embodiment 2

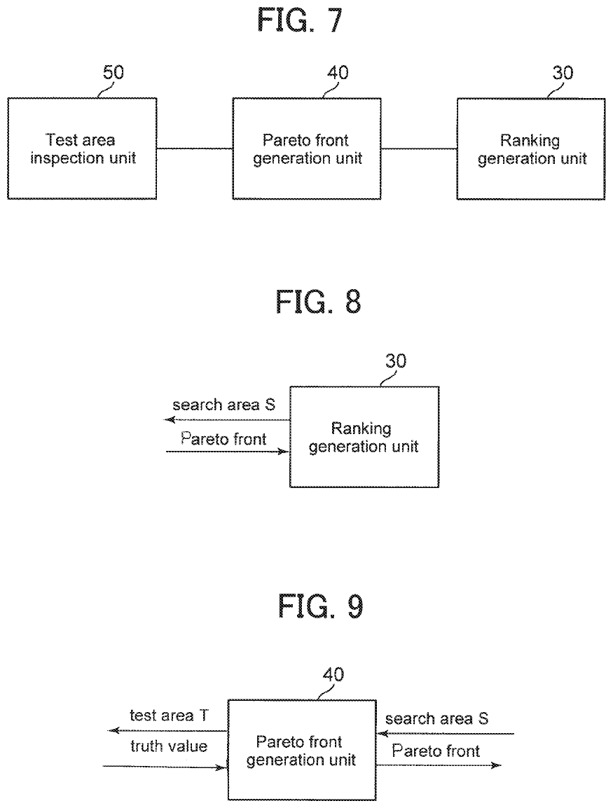

FIG. 8 is a block diagram showing a ranking generation unit 30 applicable to an exemplary embodiment of a cost ranking determining device, while FIG. 7 shows exemplary mainly functional units for determining a cost ranking on a constrained finite multivariate search space. In the first exemplary embodiment, the ranking generation unit 30 associates with the Pareto front generation unit 40 shown in FIG. 1 or FIG. 7. However, the ranking generation unit 30 can associate with other types of unit or other types of process, as long as the unit or the process provides the ranking generation unit 30 with Pareto fronts responsive to information indicating a search area S (a set of points).

### Exemplary Embodiment 3

FIG. 9 is a block diagram showing a Pareto front generation unit 40 applicable to an exemplary embodiment of a cost ranking determining device. In the first exemplary embodiment, the

Pareto front generation unit 40 associates with the ranking generation unit 30 and the test area inspection unit 50 shown in FIG. 1 or FIG. 7. However, the Pareto front generation unit 40 can associate with other types of unit or other type process instead of the ranking generation unit 30, as long as the unit or the process provides the Pareto front generation unit 40 with information indicating search area S. Also, the Pareto front generation unit 40 can associate with other types of unit or other types of process instead of the test area inspection unit 50, as long as the unit or the process provides the Pareto front generation unit 40 with a truth value.

Each of the aforementioned exemplary embodiments can be configured in hardware, but it is also possible to implement the exemplary embodiment by a computer program.

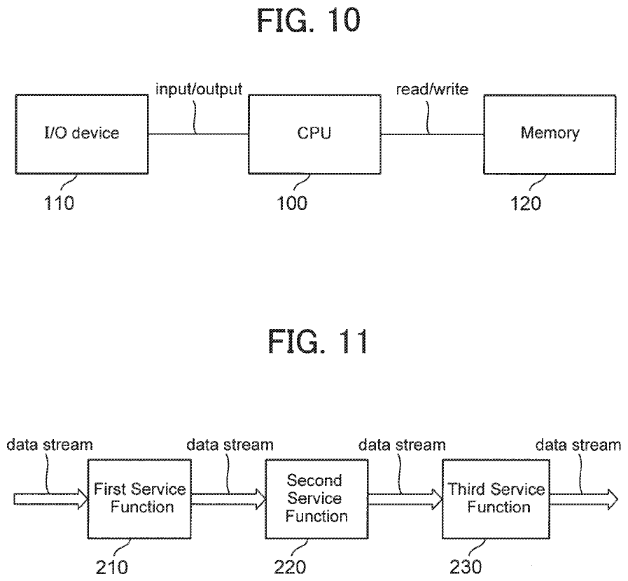

An information processing system shown in FIG. 10 includes one or more processors such as CPUs (Central Processing Unit) 100, an I/O (Input/Output) device 110 and a memory 120. In FIG. 10, the information processing system includes a CPU 100. A magnetic storage medium such as a hard disk, or a semiconductor memory such as a ROM (read only memory) or a flash memory can be used as the memory 120. The I/O device 110 can realize functions of the output unit 10 and the input unit 20 shown in FIG. 1.

The memory 120 stores a program for realizing the function of each unit shown in FIG. 1. In the memory 120, an area in which at least a program is stored is a non-transitory tangible storage area (non-transitory tangible media). In addition, the memory 120 may realize the information storage unit 60, the point storage unit 70 and the cost information storage unit 80 shown in FIG. 1. The memory 120 is separated into a memory storing the program and another memory for realizing the information storage unit 60, the point storage unit 70 and the cost information storage unit 80. The CPU 100 executes processes according to the program stored in the memory 120 to realize functions of the ranking generation unit 30, the Pareto front generation unit 40, and the test area inspection unit 50 shown in FIG. 1.

Hereinafter, although specific examples are explained, it should be noted that the present invention is not limited to the following examples.

### EXAMPLE 1

The present invention can be applied to the field of resource dimensioning of service function chains (SFC). Consider a service function chain consisting of three service functions 210, 220, 230 operating on a stream of data, as shown in FIG. 11. A realization of that service function chain by hardware and software requires sufficient amount of hardware resources, to ensure a certain level L of service quality. It is therefore of interest to have a mechanism to ensure sufficient provision of hardware resources while optimizing the total cost.

To apply this invention to the above problem, let a point X=(x_1, x_2, x_3) abstractly represent the amount of allocated hardware resources, where x_n denotes the allocation to the n-th service function, and 1<32 x_n<=K_n (for some given values of K_n). A cost to a point X is also defined, as the sum of three monotonic cost functions c_n, as: cost(X)=c_1(x_1)+c_2(x_2)+c_3(x_3).

Furthermore, it is assumed that verifying whether a service level L is reached involves a costly and time-consuming measurement. However, it is assumed that the a device or method M realizing the test area inspection unit exists, capable of the following:
(i) estimating whether the service quality of a point X is above or below level L, in this example, feasible points are defined to be equivalent to those points whose service quality is estimated by M to be higher than L,
(ii) estimating whether any interval of the form ([1, K_1], x_2, x_3), (x_1, [1, K_2], x_3), or (x_1, x_2, [1, K_3]) contains a resource allocation with service quality above level L,
(iii) estimating whether any subset of the form (x_1, [1, K_2], [1, K_3]), ([1, K_1], x_2, [1, K_3]), or ([1, K_1 ], [1, K_2], x_3) contains a resource allocation with service quality above level L, and
(iv) estimating whether there exists any resource allocation with service quality level above L.
This example can be used to generate a cost ranking of resource allocations which are estimated by M to be higher than L.

### EXAMPLE 2

Furthermore, it is assumed that a measurement and controlling device is attached to or replaces the output unit 10 and the input unit 20 in FIG. 2 or the I/O device 110 in FIG. 7, capable of;
(i) allocating resources to service functions 210,220,230, and
(ii) measuring the fulfillment of quality of service level L.

The measurement and controlling device could sequentially retrieve the ranking from the cost ranking determining device or the cost ranking determining method of the present invention and test by measurement the fulfillment of quality of service for each returned resource allocation estimation in cost order, until a resource allocation fulfilling quality of service level L by measurement is found. This measurement and controlling device would be able to determine the cheapest resource allocation by making use of the present invention.

### EXAMPLE 3

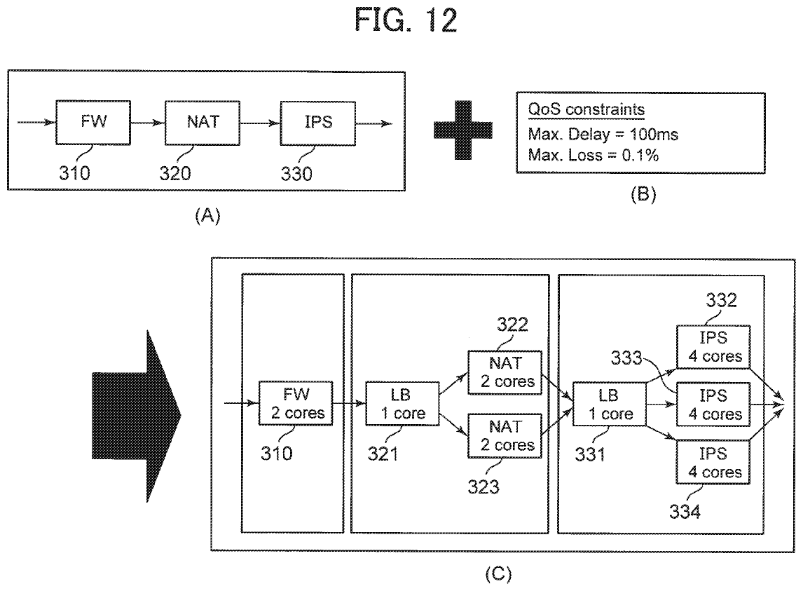

FIG. 12 shows a specific example of SFC. It is assumed that SFC shown in (A) of FIG. 12 exists. The SFC comprises a FW (Firewall) 310, a NAT (Network Access Translation) 320 and IPS (Intrusion Prevention System) 330 as first to third stages of VNF (Virtual Network Function). Constraints are shown in (B) of FIG. 12, for example. Thus, Constraints are QoS (Quality of Service) constraints in this example. For example, the QoS constraints includes 100 ms as the maximum delay and 0.1% as a maximum loss.

The cheapest system configuration by cost ranking determining is shown in (C) of FIG. 12. In the example shown in (C) of FIG. 12, the FW 310 is determined in such a way as to consist of 2 cores processor. NAT 320 is determined in such a way as to consist of a LB (Load Balancer) 321, a 2-cores NAT 322 and anther 2-cores NAT 323. IPS 330 is determined in such a way as to consist of LB 331, a 4-cores IPS 332, another 4-cores IPS 333 and another 4-cores IPS 334.

According to the cost ranking determining device and the cost ranking determining method of the above exemplary embodiments, the cheapest system configuration which is feasible, i.e. satisfies the constraints is obtained in a shorter time.

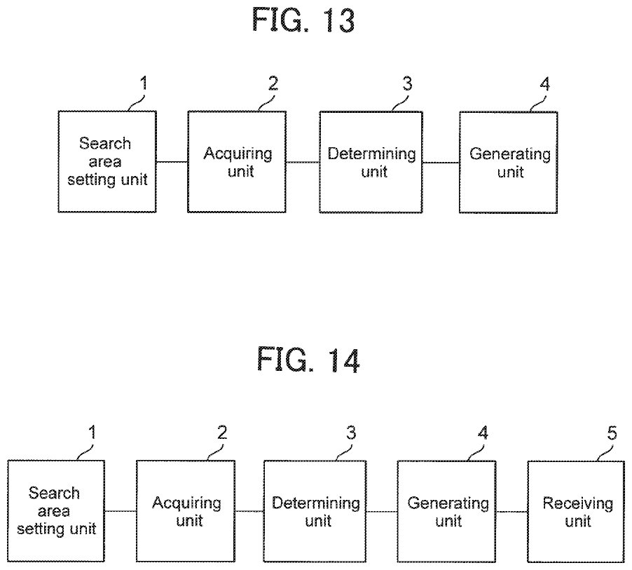

FIG. 13 is a block diagram showing main parts of a cost ranking determining device according to the present invention. As shown in FIG. 13, the cost ranking determining device comprises a search area setting unit 1 (realized by the ranking generation unit 30 in the exemplary embodiments) which initially sets a search area where solution candidates are included, and serially sets a new search area based on one or more of the determined Pareto points, an acquiring unit 2 (realized by the Pareto front generation unit 40 in the exemplary embodiments) which acquires information whether the search area includes a solution candidate or solution candidates satisfying predetermined constraints, and the new search area include a solution candidate or solution candidates satisfying predetermined constraints, a determining unit 3 (realized by the Pareto front generation unit 40 in the exemplary embodiments) which determines Pareto points in the search area and the new search area under the condition where a solution candidate satisfying the constraints is regarded as a solution, and a generating unit 4 (realized by the ranking generation unit 30 in the exemplary embodiments) which generates a ranking of the solutions in cost according to Pareto front.

FIG. 14 is a block diagram showing main parts of another cost ranking determining device according to the present invention. As shown in FIG. 14, the cost ranking determining device further comprises a receiving unit 5 (realized by the input unit 20 in the exemplary embodiments) which receives the ranked solutions from the generating means.

It should be noted that the cost ranking determining device shown in FIG. 13 or FIG. 14 can be realized by the information processing system shown in FIG. 10. Thus, the search area setting unit 1, the acquiring unit 2, the determining unit 3 and the generating unit 4 can be realized by the CPU 100 performing processes according to the program stored in the memory 120. The receiving unit 5 can be realized by the I/O device 110.

The foregoing exemplary embodiments may be partly or wholly described in the following supplementary notes, though the structure of the present invention is not limited to such.
(Supplementary note 1) A cost ranking determining method for determining a cost ranking comprising initially setting a search area where solution candidates are included, acquiring information whether the search area includes a solution candidate or solution candidates satisfying predetermined constraints, determining Pareto points in the search area under the condition where a solution candidate satisfying the constraints is regarded as a solution, serially setting a new search area based on one or more of the determined Pareto points, acquiring information whether the new search area includes a solution candidate or solution candidates satisfying predetermined constraints, determining Pareto points in the new search area under the condition where a solution candidate satisfying the constraints is regarded as a solution, and generating a ranking of the solutions in cost according to the determined Pareto fronts.
(Supplementary note 2) A method applicable to a cost ranking determining method for determining a cost ranking comprising initially setting a search area where solution candidates are included, receiving Pareto points in the search area under the condition where a solution candidate satisfying the constraints is regarded as a solution, serially setting a new search area based on one or more of the determined Pareto points, receiving Pareto points in the new search area under the condition where a solution candidate satisfying the constraints is regarded as a solution, and generating a ranking of the solutions in cost according to the determined Pareto fronts.
(Supplementary note 3) A method applicable to a cost ranking determining method for determining a cost ranking comprising acquiring information whether a search area includes a solution candidate or solution candidates satisfying predetermined constraints, determining Pareto points in the search area under the condition where a solution candidate satisfying the constraints is regarded as a solution, acquiring information whether a new search area based on one or more of the determined Pareto points includes a solution candidate or solution candidates satisfying predetermined constraints, and determining Pareto points in the new search area under the condition where a solution candidate satisfying the constraints is regarded as a solution.
(Supplementary note 4) The cost ranking determining method according to Supplementary note 1, wherein a new search area is set based on the set of cheapest Pareto points at the time.
(Supplementary note 5) The cost ranking determining method according to Supplementary note 4, wherein a new search area is set that such that it contains all remaining solution candidates with cost less than the cost of each remaining Pareto point.
(Supplementary note 6) The method according to Supplementary note 2, wherein a new search area is set on the set of cheapest Pareto points at the time.
(Supplementary note 7) The method according to Supplementary note 6, wherein a new search area is set based on the set of cheapest Pareto points at the time.
(Supplementary note 8) A cost ranking determining device for determining a cost ranking comprising search area setting means for initially setting a search area where solution candidates are included, and serially setting a new search area based on one or more of the determined Pareto points, acquiring means for acquiring information whether the search area includes a solution candidate or solution candidates satisfying predetermined constraints, and the new search area includes a solution candidate or solution candidates satisfying predetermined constraints, determining means for determining Pareto points in the search area and the new search area under the condition where a solution candidate satisfying the constraints is regarded as a solution, and generating means for generating a ranking of the solutions in cost according to the determined Pareto fronts.
(Supplementary note 9) A device applicable to a cost ranking determining device for determining a cost ranking comprising search area setting means for initially setting a search area where solution candidates are included, and serially setting a new search area based on one or more of the determined Pareto points, receiving means for receiving Pareto points in the search area and the new search area under the condition where a solution candidate satisfying the constraints is regarded as a solution, and generating means for generating a ranking of the solutions in cost according to the determined Pareto fronts.
(Supplementary note 10) A device applicable to a cost ranking determining device for determining a cost ranking comprising acquiring means for acquiring information whether the search area includes a solution candidate or solution candidates satisfying predetermined constraints, and the new search area includes a solution candidate or solution candidates satisfying predetermined constraints, and determining means for determining Pareto points in the search area and the new search area under the condition where a solution candidate satisfying the constraints is regarded as a solution.
(Supplementary note 11) The cost ranking determining device according to Supplementary note 8, wherein the search area setting means sets a new search area based on the set of cheapest Pareto points at the time.
(Supplementary note 12) The cost ranking determining device according to Supplementary note 11, wherein the search area setting means sets a new search area such that it contains all remaining solution candidates with cost less than the cost of each remaining Pareto point.
(Supplementary note 13) The cost ranking determining device according to Supplementary note 8, 11 or 12, further comprising, receiving means for receiving the ranked solutions from the generating means.
(Supplementary note 14) A device according to Supplementary note 9, wherein the search area setting means sets a new search area based on the set of cheapest Pareto points at the time.
(Supplementary note 15) A device according to Supplementary note 14, wherein the search area setting means sets a new search area such that it contains all remaining solution candidates with cost less than the cost of each remaining Pareto point.

(Supplementary note 16) A cost ranking determining program for determining a cost ranking, for causing a computer to execute a process of initially setting a search area where solution candidates are included, a process of acquiring information whether the search area includes a solution candidate or solution candidates satisfying predetermined constraints, a process of determining Pareto points in the search area under the condition where a solution candidate satisfying the constraints is regarded as a solution, a process of serially setting a new search area based on one or more of the determined Pareto points, a process of acquiring information whether the new search area includes a solution candidate or solution candidates satisfying predetermined constraints, a process of determining Pareto points in the new search area under the condition where a solution candidate satisfying the constraints is regarded as a solution, and a process of generating a ranking of the solutions in cost according to the determined Pareto fronts.
(Supplementary note 17) A program applicable to a cost ranking determining program for determining a cost ranking, for causing a computer to execute a process of initially setting a search area where solution candidates are included, a process of receiving Pareto points in the search area under the condition where a solution candidate satisfying the constraints is regarded as a solution, a process of serially setting a new search area based on one or more of the determined Pareto points, a process of receiving Pareto points in the new search area under the condition where a solution candidate satisfying the constraints is regarded as a solution, and a process of generating a ranking of the solutions in cost according to the determined Pareto fronts.
(Supplementary note 18) A program applicable to a cost ranking determining program for determining a cost ranking, for causing a computer to execute a process of acquiring information whether a search area includes a solution candidate or solution candidates satisfying predetermined constraints, a process of determining Pareto points in the search area under the condition where a solution candidate satisfying the constraints is regarded as a solution, a process of acquiring information whether a new search area based on one or more of the determined Pareto points includes a solution candidate or solution candidates satisfying predetermined constraints, and a process of determining Pareto points in the new search area under the condition where a solution candidate satisfying the constraints is regarded as a solution.
(Supplementary note 19) The cost ranking determining program according to Supplementary note 16, wherein a new search area is set based on the set of cheapest Pareto points at the time.
(Supplementary note 20) The cost ranking determining program according to Supplementary note 19, wherein a new search area is set such that it contains all remaining solution candidates with cost less than the cost of each remaining Pareto point.
(Supplementary note 21) The program according to Supplementary note 17, wherein a new search area is set based on the set of cheapest Pareto points at the time.
(Supplementary note 22) The program according to Supplementary note 21, wherein a new search area is set such that it contains all remaining solution candidates with cost less than the cost of each remaining Pareto point.
(Supplementary note 23) A cost ranking determining device for determining a cost ranking comprising a search area setting unit which initially sets a search area where solution candidates are included, and serially sets a new search area based on one or more of the determined Pareto points, an acquiring unit which acquires information whether the search area includes a solution candidate or solution candidates satisfying predetermined constraints, and the new search area include the solution candidate or candidates satisfying predetermined constraints, a determining unit which determines Pareto points in the search area and the new search area under the condition where a solution candidate satisfying the constraints is regarded as a solution, and a generating unit which generates a ranking of the solutions in cost according to the determined Pareto fronts.
(Supplementary note 24) A non-transitory computer readable information recording medium storing a cost ranking determining program for determining a cost ranking, when executed by a processor, performs, initially setting a search area where solution candidates are included, acquiring information whether the search area includes a solution candidate or solution candidates satisfying predetermined constraints, determining Pareto points in the search area under the condition where a solution candidate satisfying the constraints is regarded as a solution, serially setting a new search area based on one or more of the determined Pareto points, acquiring information whether the new search area includes a solution candidate or solution candidates satisfying predetermined constraints, determining Pareto points in the new search area under the condition where a solution candidate satisfying the constraints is regarded as a solution, and generating a ranking of the solutions in cost according to the determined Pareto fronts.

While the present invention has been described with reference to the exemplary embodiments and examples, the present invention is not limited to these exemplary embodiments and examples. Various changes understandable by those skilled in the art can be made to the structures and details of the present invention within the scope of the present invention.

### INDUSTRIAL APPLICABILITY

This invention can be used to solve any kind of planning (e.g. resource planning) problem that can be expressed within the category of problems.

### REFERENCE SIGNS LIST

1 search area setting unit
2 acquiring unit
3 determining unit
4 generating unit
5 receiving unit
10 input unit
20 output unit
30 ranking generation unit
40 Pareto front generation unit
50 test area inspection unit
60 information storage unit
70 point storage unit
80 cost information storage unit
100 CPU
110 I/O device
120 memory Docket No.

What is claimed is:

1. A cost ranking determining method, implemented by a processor, for determining a cost ranking, comprising;
initially setting a search area where solution candidates are included,
acquiring information whether the search area includes a solution candidate or solution candidates satisfying predetermined constraints,
determining Pareto points in the search area under the condition where a solution candidate satisfying the constraints is regarded as a solution,
serially setting a new search area based on one or more of the determined Pareto points,
acquiring information whether the new search area includes a solution candidate or solution candidates satisfying predetermined constraints,
determining Pareto points in the new search area under the condition where a solution candidate satisfying the constraints is regarded as a solution, and
generating a ranking of the solutions in cost according to the determined Pareto fronts.

2-3. (canceled)

4. The cost ranking determining method according to claim 1, wherein a new search area is set based on the set of cheapest Pareto points at the time.

5. The cost ranking determining method according to claim 4,
wherein a new search area is set such that it contains all remaining solution candidates with cost less than the cost of each remaining Pareto point.

6. A cost ranking determining device for determining a cost ranking, comprising;
a search area setting unit implemented by a processor, which initially sets a search area where solution candidates are included, and serially sets a new search area based on one or more of the determined Pareto points,
an acquiring unit implemented by the processor, which acquires information whether the search area includes a solution candidate or solution candidates satisfying predetermined constraints, and the new search area includes a solution candidate or solution candidates satisfying predetermined constraints,
a determining unit implemented by the processor, which determines Pareto points in the search area and the new search area under the condition where a solution candidate satisfying the constraints is regarded as a solution, and
a generating unit implemented by the processor, which generates a ranking of the solutions in cost according to the determined Pareto fronts.

7. The cost ranking determining device according to claim 6,
wherein the search area setting unit sets a new search area based on the set of cheapest Pareto points at the time.

8. The cost ranking determining device according to claim 7,
wherein the search area setting unit sets a new search area such that it contains all remaining solution candidates with cost less than the cost of each remaining Pareto point.

9. The cost ranking determining device according to claim 6, further comprising, a receiving unit implemented by the processor, which receives the ranked solutions from the generating unit.

10. A cost A non-transitory computer readable information recording medium storing a cost ranking determining program for determining a cost ranking, when executed by a processor, performs:
setting a search area where solution candidates are included,
acquiring information whether the search area includes a solution candidate or solution candidates satisfying predetermined constraints,
determining Pareto points in the search area under the condition where a solution candidate satisfying the constraints is regarded as a solution,
serially setting a new search area based on one or more of the determined Pareto points,
acquiring information whether the new search area includes a solution candidate or solution candidates satisfying predetermined constraints,
determining Pareto points in the new search area under the condition where a solution candidate satisfying the constraints is regarded as a solution, and
generating a ranking of the solutions in cost according to the determined Pareto fronts.

11. The cost ranking determining device according to claim 7, further comprising, a receiving unit implemented by the processor, which receives the ranked solutions from the generating unit.

12. The cost ranking determining device according to claim 8, further comprising, a receiving unit implemented by the processor, which receives the ranked solutions from the generating unit.
